(19) United States
(12) Patent Application Publication
(10) Pub. No.: US 2025/0333096 A1
(43) Pub. Date: Oct. 30, 2025

(54) STEERING CONTROL ANGLE COMPENSATION METHOD FOR LANE KEEPING AND LANE KEEPING CONTROL DEVICE

(71) Applicant: Magna Electronics Sweden AB, Vårgårda (SE)

(72) Inventors: Ju-Won PARK, Hwaseong-si (KR); Hoon BAE, Hwaseong-si (KR); Seong-Min SON, Hwaseong-si (KR)

(21) Appl. No.: 19/097,146

(22) Filed: Apr. 1, 2025

(30) Foreign Application Priority Data
Apr. 26, 2024 (KR) 10-2024-56282

(51) Int. Cl. B62D 1/28

(52) U.S. Cl. CPC B62D 1/28

(57) ABSTRACT

The disclosure relates to a steering control angle compensation method for compensating for a steering control angle for lane keeping considering characteristics of a vehicle, and a lane keeping control device.

### CROSS REFERENCE TO RELATED APPLICATIONS

This U.S. utility patent application claims the benefit of Korean Patent Application No. KR10-2024-56282, filed Apr. 26, 2024, the content of which is incorporated herein by reference in its entirety.

### FIELD

The present disclosure relates generally to a steering control angle compensation method for compensating for a steering control angle for lane keeping considering characteristics of a vehicle, and a lane keeping control device.

### BACKGROUND

A vehicle refers to a means of travel or a means of transportation that travels on a road or lane using fossil fuels, electricity, etc. as a power source. The vehicle may travel to various positions by using one or more wheels installed in its body. Such vehicles may include three-wheeled vehicles or four-wheeled vehicles, two-wheeled vehicles such as motor cycles, etc., construction machines, bicycles, and trains traveling on rails arranged on tracks.

In the modern society, vehicles are the most common means of transportation and the number of people using vehicles is growing. Thanks to the development of vehicle technology, it becomes easy to travel long distances, and there is an advantage of easy living, but in places with high population density like Korea, road traffic conditions deteriorate and traffic congestion becomes serious.

Recently, researches are being actively conducted on vehicles provided with advanced driver assist systems (ADASs) that actively provide information on vehicle states, driver states, and surrounding environments to reduce drivers' burden and improve convenience.

Functions provided by the ADAS mounted in vehicles may include, for example, a lane departure prevention assist function, a lane keeping assist function, a smart cruise control function, or the like.

Such an ADAS determines a vehicle state based on a sensor, and controls the vehicle accordingly. For example, the ADAS determines a steering angle that a user intends, based on a steering wheel angle sensor, to keep the lane of the vehicle.

Values sensed by sensors include errors in most cases, and the same applies to the steering wheel angle sensor. Considering that a vehicle travels at high speed, an even small error in the steering angle may cause a large displacement of the vehicle.

Related-art technologies have a problem that vehicles vibrate in the transverse direction as they progress since an error in the steering wheel angle sensor is not considered, or a user should operate the steering wheel considering this.

### SUMMARY

### Objects to be Solved

The disclosure has been developed to solve the above-described problem, and an object of the disclosure is to dynamically calculate an offset considering a state of a vehicle and to apply the same to control of the vehicle.

In addition, an object of the disclosure is to enhance stability of an ADAS mounted in a vehicle by applying a dynamic offset.

### Means for Solving the Problem

According to an embodiment of the disclosure, a steering control angle compensation method for lane keeping may include: a step of determining a first offset which is an initial offset to be applied to a steering control angle in a first drive; a step of determining whether at least one condition of one or more first conditions related to characteristics of a lane on which driving is performed in the first drive, one or more second conditions related to characteristics of a vehicle associated with the lane in the first drive, and one or more third conditions related to driving characteristics of the vehicle in the first drive is satisfied; a step of determining a second offset which is a candidate offset for the first drive, based on a duration for which the at least one condition is satisfied and the first offset; and a step of determining a third offset which is an offset to be applied to steering angle control of the vehicle, based on one or more reference offsets that are determined in one or more second drives before the first drive, and the second offset.

The step of determining the first offset may include a step of determining the first offset based on the one or more reference offsets stored in a memory.

The step of determining whether the at least one condition is satisfied may include: a step of determining whether the one or more first conditions related to the characteristics of the lane on which driving is performed in the first drive are satisfied; a step of determining whether the one or more second conditions related to the characteristics of the vehicle associated with the lane in the first drive are satisfied; and a step of determining whether the one or more third conditions related to the driving characteristics of the vehicle in the first drive are satisfied.

The one or more first conditions may include a condition where the lane corresponds to a straight line lane, a condition where a curvature of the lane is less than a predetermined threshold value, a condition where a change rate in the curvature per unit length of the lane is less than a predetermined threshold value, a condition where a length of the lane exceeds a predetermined threshold value, and a condition where the curvature of the lane determined from filtered data of the lane is less than a predetermined threshold value.

The first condition may be determined based on an image related to the first drive of the vehicle, and the one or more first conditions may further include a condition where a reliability of an image acquisition device which provides an image related to the first drive exceeds a predetermined threshold value.

The one or more second conditions may include a condition where a distance between a center of the lane and a center of the vehicle is less than a predetermined threshold value, a condition where an angle of an advancing direction of the vehicle relative to an extension direction of the lane that is determined based on filtered data of the lane is less than a predetermined threshold value, a condition where the angle of the advancing direction of the vehicle relative to the extension direction of the lane is less than a predetermined threshold value, a condition where a speed of the vehicle on the lane is within a range that is defined by a lower limit and an upper limit, and a condition where the vehicle travels along two lines which define the lane in a width direction.

The one or more third conditions may include a condition where an acceleration of the vehicle in an extension direction of the lane is less than a threshold value, a condition where an acceleration of the vehicle in a width direction of the lane is less than a threshold value, a condition where an angular acceleration of the vehicle rotating relative to the lane is less than a threshold value, a condition where a torque applied to a steering axis of the vehicle by at least one of a driver and an environment of the lane is less than a predetermined threshold value, and a condition where a torque applied to the steering axis by the vehicle according to a control signal of the vehicle is less than a predetermined threshold value.

The step of determining the second offset may include a step of, when a length of a time period for which the at least one condition is continuously satisfied in a state in which the first offset is applied to the steering control angle exceeds a predetermined threshold length, determining the second offset to be the same value as the first offset.

The step of determining the third offset may include a step of determining a representative value of the one or more reference offsets and the second offset in a predetermined method; and a step of determining the representative value as the third offset.

According to an embodiment of the disclosure, the steering control angle compensation method may further include, after the step of determining the third offset, a step of applying the third offset to the steering angle control of the vehicle.

According to an embodiment of the disclosure, there is provided a lane keeping control device including a processor, wherein the processor is configured to: determine a first offset which is an initial offset to be applied to a steering control angle in a first drive; determine whether at least one condition of one or more first conditions related to characteristics of a lane on which driving is performed in the first drive, one or more second conditions related to characteristics of a vehicle associated with the lane in the first drive, and one or more third conditions related to driving characteristics of the vehicle in the first drive is satisfied; determine a second offset which is a candidate offset for the first drive, based on a duration for which the at least one condition is satisfied, and the first offset; and determine a third offset which is an offset to be applied to steering angle control of the vehicle, based on one or more reference offsets that are determined in one or more second drives before the first drive, and the second offset.

According to an embodiment of the disclosure, there is provided a vehicle including a lane keeping control device, wherein the lane keeping control device is configured to: determine a first offset which is an initial offset to be applied to a steering control angle in a first drive; determine whether at least one condition of one or more first conditions related to characteristics of a lane on which driving is performed in the first drive, one or more second conditions related to characteristics of a vehicle associated with the lane in the first drive, and one or more third conditions related to driving characteristics of the vehicle in the first drive is satisfied; determine a second offset which is a candidate offset for the first drive, based on a duration for which the at least one condition is satisfied, and the first offset; and determine a third offset which is an offset to be applied to steering angle control of the vehicle, based on one or more reference offsets that are determined in one or more second drives before the first drive, and the second offset.

### Effects of the Invention

According to the disclosure, an offset may be dynamically calculated considering a state of a vehicle and may be applied to control of the vehicle.

In addition, stability of an advanced driver assist system mounted in a vehicle may be enhanced by dynamic application of an offset.

These and other aspects of the present disclosure are disclosed in the following detailed description of the embodiments, the appended claims, and the accompanying figures.

### BRIEF DESCRIPTION OF THE DRAWINGS

FIG. 1 and FIG. 2 show a view to explain a configuration of a vehicle 1 including a lane keeping control device according to an embodiment of the disclosure;

FIG. 3 is a view illustrating a list of detailed conditions belonging to a first condition, a second condition, and a third condition described above;

FIG. 4 is a view to explain parameters used for describing detailed conditions;

FIGS. 5 to 8 are flowcharts to explain a steering control angle compensation method performed by a lane keeping control device according to an embodiment of the disclosure.

### DETAILED DESCRIPTION

The disclosure may have various changes made thereto, and may have various embodiments, and specific embodiments are illustrated in the drawings and described in detail in the detailed descriptions. Effects and features of the disclosure and methods for achieving the same will be clarified with reference to embodiments described in detail below with the accompanying drawings. However, the disclosure is not limited to the embodiments disclosed herein and may be embodied in various forms.

Hereinafter, embodiments of the disclosure will be described in detail with reference to the accompanying drawings, and in describing with reference to the drawings, the same or corresponding components are given the same reference numerals and redundant explanations thereof are omitted.

In the embodiments described hereinbelow, such terms as first and second do not limit the components and are used to simply distinguish one component from another component. In the embodiments described hereinbelow, the singular forms are intended to include the plural forms unless the context clearly indicates otherwise. In the embodiments described hereinbelow, the term “include” or “have” means existence of features or components described in the specification, and does not preclude the addition of one or more other features or components. For the convenience of explanation, the sizes of components may be exaggerated or reduced in the drawings. For example, the size and shape of each configuration illustrated in the drawings are arbitrarily shown for the convenience of explanations, and the disclosure is not necessarily limited to those illustrated in the drawings.

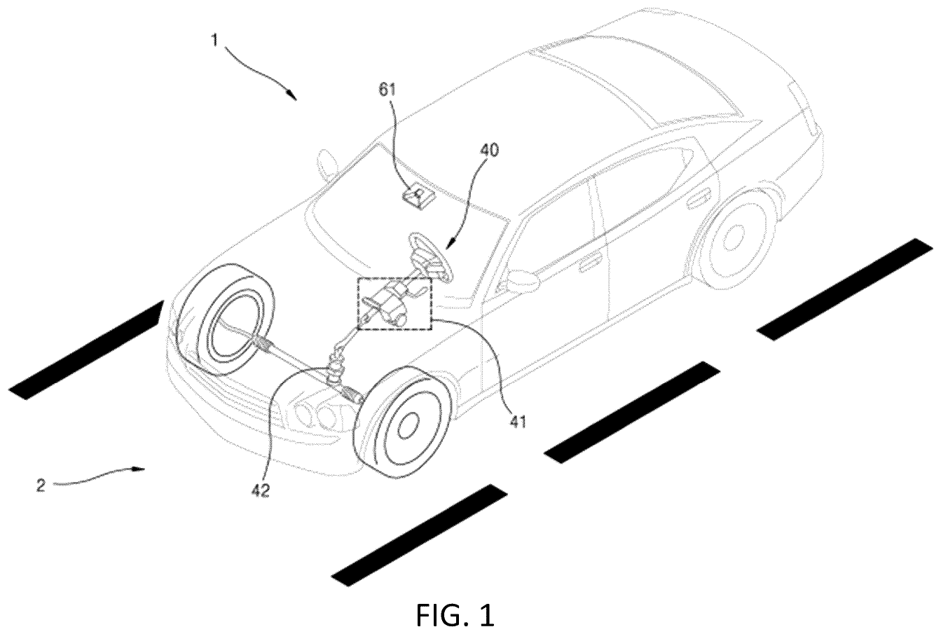

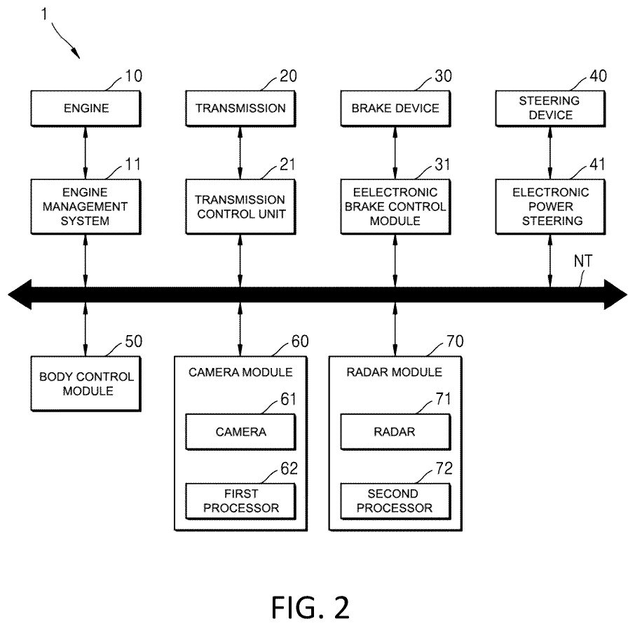

FIGS. 1 and 2 are views to explain a configuration of a vehicle 1 including a lane keeping control device according to an embodiment of the disclosure. Hereinafter, the disclosure will be described by referring to FIGS. 1 and 2 together for the convenience of explanation.

The lane keeping control device according to an embodiment of the disclosure may compensate for a steering control angle for lane keeping considering characteristics of the vehicle 1. For example, the lane keeping control device may determine an offset for compensating for the steering control angle, and may apply the determined offset to control of the steering of the vehicle 1. However, the above-described method is exemplary and the idea of the disclosure is not limited thereto.

In the disclosure, the ‘vehicle 1’ may refer to various types of devices that move locations by assisting user's operation or without user's operation. For example, the vehicle 1 may refers to various types of vehicles that move on the ground through friction with the ground as shown in FIG. 1. In this case, the vehicle may refer to a vehicle in which a person rides, or a mechanical device that carries cargo or the like without a person riding therein as shown in FIG. 1. In the following descriptions, it is assumed that the vehicle 1 is a vehicle in the form shown in FIG. 1 for the convenience of explanation.

In the disclosure, the ‘lane 2’ may refer to a part of a road that is divided by lines so that the vehicle 1 passes through a defined portion on the road. In addition, the ‘line’ may refer to a line that is drawn on a road to divide the road into one or more lanes, in the disclosure.

As shown in FIGS. 1 and 2, the vehicle 1 according to an embodiment of the disclosure may include an engine 10, a transmission 20, a brake device 30, a steering device 40, a body control module 50, a camera module 60, and a radar module 70.

The engine 10 may include a cylinder and a piston, and may generate power for the vehicle 1 to travel. In another embodiment of the disclosure, the vehicle 1 may include a motor (not shown) that is driven by electricity along with or in place of the engine 10. In this case, the power of the vehicle 1 may be generated from the motor (not shown) driven by a battery (not shown).

The transmission 20 may include a plurality of gears, and may transmit power generated by the engine 10 to wheels. In another embodiment of the disclosure, when the engine 10 is configured by a motor that is driven by electricity, the transmission 20 may be omitted from the vehicle 1.

The brake device 30 may decelerate or stop the vehicle 1 through friction with wheels.

The steering device 40 may change a driving direction of the vehicle 1.

The vehicle 1 according to an embodiment of the disclosure may further include a component for controlling the above-described components 10, 20, 30, 40 of the vehicle 1. For example, the vehicle 1 may include an engine management system (EMS) 11 to control the engine 10, a transmission control unit (TCU) 21 to control the transmission 20, an electronic brake control module 31 to control the brake device 30, and an electronic power steering (EPS) 41 to control the steering device 40.

The engine management system 11 according to an embodiment of the disclosure may control the engine 10 according to a user's intent to accelerate via an accelerator pedal or a request of a vehicle communication network (NT). For example, the engine management system 11 may control a torque and/or the number of rotations of the engine 10.

The transmission control unit 21 according to an embodiment of the disclosure may control the transmission 20 in response to a transmission command of the user through a transmission lever and/or a driving speed of the vehicle 1. For example, the transmission control unit 21 may adjust a transmission rate from the engine 10 to the wheels.

The electronic brake control module 31 according to an embodiment of the disclosure may control the brake device 30 in response to a user's intent to brake through a brake pedal, and/or a slip of wheels. For example, the electronic brake control module 31 may temporarily release the brake of the wheels in response to the sleep of the wheels that is detected when the vehicle 1 brakes. The electronic brake control module 31 may selectively release the brake of the wheels in response to an oversteering and/or understeering that is detected when the vehicle 1 is steered. In addition, the electronic brake control module 31 may temporarily brake the wheels in response to the sleep of the wheels that is detected when the vehicle 1 is driven.

The electronic power steering 41 according to an embodiment of the disclosure may assist operations of the steering device 40 in response to a user's intent to steer through a steering wheel, so that the user can easily operate the steering wheel. For example, the electronic power steering 41 may assist the operations of the steering device 40 to reduce steering power when driving at low speed or parking, and to increase steering power when driving at high speed.

The vehicle 1 according to an embodiment of the disclosure may further include an angle sensor 42 to detect an angle of the steering wheel as a component of the electronic power steering 41. The vehicle 1 may further include a torque sensor (not shown) as a component of the electronic power steering 41 although it is not illustrated in the drawings. The torque sensor (not shown) may acquire various physical quantities related to a torque applied to the steering wheel. For example, the torque sensor (not shown) may detect a magnitude of a torque applied to the steering wheel, a change rate of the torque, a change speed of the torque, etc.

The vehicle 1 according to an embodiment of the disclosure may further include a component for providing convenience of the user in addition to the above-described components. For example, the vehicle 1 may further include the body control module 50, the camera module 60, and the radar module 70.

The body control module 50 according to an embodiment of the disclosure may control operations of components for providing convenience to the user or guaranteeing safety of the user. For example, the body control module 50 may control a head lamp, a wiper, a cluster, a multi-function switch, a turn signal lamp, etc.

The camera module 60 according to an embodiment of the disclosure may include a camera 61 and a first processor 62, and may photograph the front of the vehicle 1 and recognize other moving objects, pedestrians, lines, road signs, etc. The camera module 60 may calculate a compensation value of a steering control angle for lane keeping, which will be described in detail later.

The radar module 70 according to an embodiment of the disclosure may include a radar 71 and a second processor 72, and may acquire relative positions, relative velocities of objects (for example, other moving objects, pedestrians) around the vehicle 1.

The components 50, 60, 70 for providing convenience to the user as described above may provide various convenience functions. For example, the components 50, 60, 70 may provide a lane departure warning (LDW) function, a lane keeping assist (LKA) function, a lane following assist (LFA) function, a high beam assist (HBA) function, an autonomous emergency braking (AEB) function, a traffic sign recognition (TSR) function, a smart cruise control (SCC) function, and a blind spot detection (BSD) function, etc. However, the above-described convenience functions are exemplary, and the idea of the disclosure is not limited thereto.

The vehicle 1 according to an embodiment of the disclosure may further include the vehicle communication network (NT), and the above-described components 11, 21, 31, 41, 50, 60, 70 may communicate with one another through the vehicle communication network (NT). For example, the above-described components 11, 21, 31, 41, 50, 60, 70 may exchange data with one another through Ethernet, media oriented systems transport (MOST), Flexray, controller area network (CAN), local interconnect network (LIN), etc.

The ‘lane keeping control device’ described in the disclosure may be a device that is configured to include at least some of the components of the vehicle 1 described above. For example, the lane keeping control device may include only the camera module 60 or the first processor 62 in the camera module 60, and may operate by receiving a necessary control signal from the remaining components. The lane keeping control device may include all of the steering device 40, the electronic power steering 41, and the camera module 60 to operate as a single device.

Hereinafter, a steering control angle compensation process of the first processor 62 will be described on the assumption that the first processor 62 is included in the lane keeping control device.

The first processor 62 according to an embodiment of the disclosure may determine a first offset which is an initial offset to be applied to a steering control angle in a first drive. For example, the first processor 62 according to an embodiment of the disclosure may determine the first offset based on one or more reference offsets that are stored in a memory (not shown) of the camera module 60 or a memory (not shown) of other modules. For example, the first processor 62 may determine the first offset to be +0.3 degree by referring to +0.3 degree which is an offset of the previous drive. However, this is merely an example and the idea of the disclosure is not limited thereto.

The ‘reference offset’ in the disclosure may refer to an offset that is determined in one or more second drives before the first drive.

In the disclosure, the ‘first drive’ may refer to a corresponding drive. In this case, the ‘corresponding drive’ may refer to a drive that is defined by the time from the start of the vehicle 1 to the end of the drive. Accordingly, the ‘second drive’ may refer to a previous drive that is defined by the start and the end of the drive before the corresponding drive.

The first processor 62 according to an embodiment of the disclosure may determine whether at least one condition of one or more first conditions related to characteristics on the lane 2 where the vehicle travels during the first drive, one or more second conditions related to characteristics of the vehicle 1 associated with the lane 2, and one or more third conditions related to driving characteristics of the vehicle 1 is satisfied.

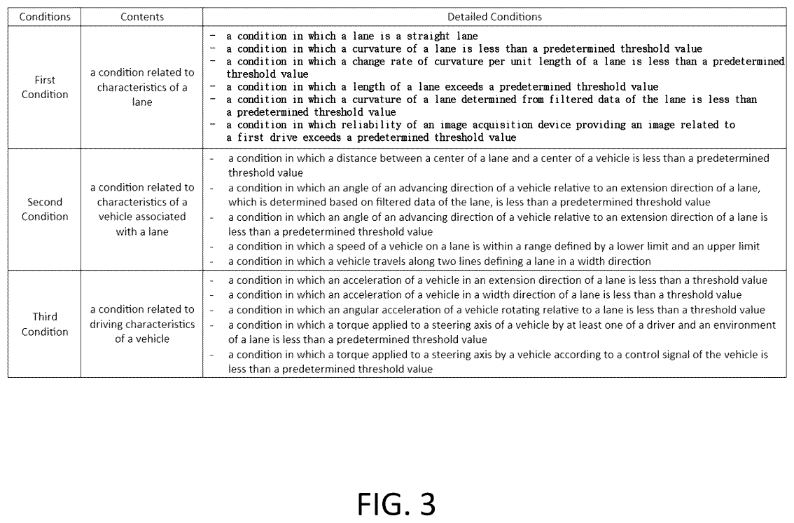

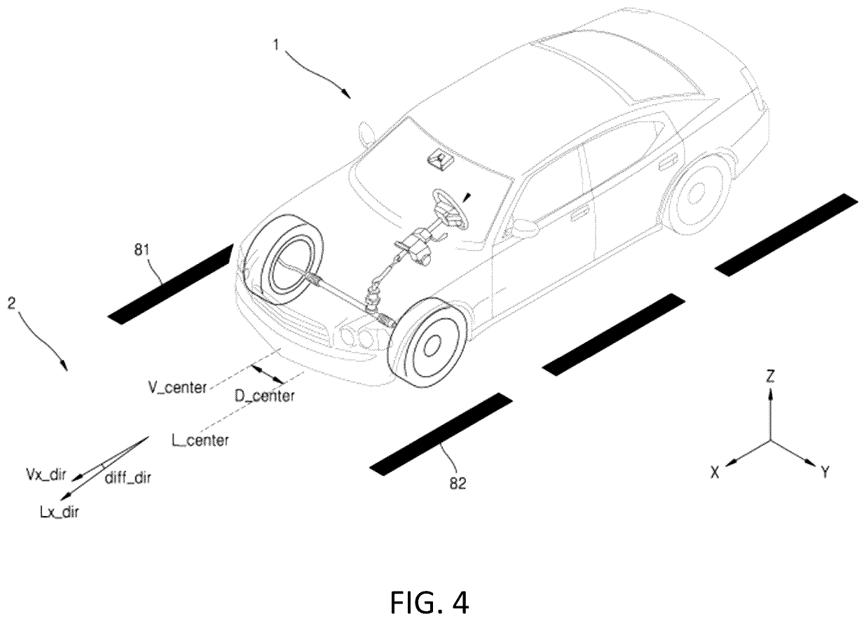

FIG. 3 is a view illustrating a list of detailed conditions belonging to the first condition, the second condition, and the third condition described above. FIG. 4 is a view to explain parameters used for describing the detailed conditions. Hereinafter, the disclosure will be described by referring to FIGS. 3 and 4 together.

In the disclosure, the one or more first conditions may be related to characteristics of the lane, and may include a condition where the lane 2 corresponds to a straight line lane, a condition where a curvature of the lane 2 is less than a predetermined threshold value, a condition where a change rate of the curvature per unit length of the lane 2 is less than a predetermined threshold value, a condition where the length of the lane 2 exceeds a predetermined threshold value, and a condition where the curvature of the lane 2 determined from filtered data of the lane is less than a predetermined threshold value.

The first processor 62 according to an embodiment of the disclosure may determine whether the above-described one or more first conditions are all satisfied, and may determine whether the second condition described later is satisfied when all of the first conditions are satisfied. When any one of the first conditions is not satisfied, the first processor 62 may continue to determine whether the one or more first conditions are satisfied until all of the first conditions are satisfied.

In the disclosure, the ‘filtered data of the lane’ may refer to data that results from passing of image data obtained by the camera 61 through a filter having a predetermined pass band. For example, the filtered data of the lane may refer to data that results from passing of image data through a low-frequency filter. However, this is exemplary and the idea of the disclosure is not limited thereto.

In the disclosure, conditions without restrictions on filtering, such as whether the lane 2 corresponds to a straight line lane and whether the curvature of the lane 2 is less than a predetermined threshold may be determined based on image data that is obtained by the camera 61.

The first condition may further include a condition where reliability of an image acquisition device which provides an image related to the first drive exceeds a predetermined threshold value, in addition to the above-described conditions. For example, the first condition may further include a condition where reliability of the camera 61 exceeds a predetermined threshold value.

In the disclosure, the one or more second conditions may be related to characteristics of the vehicle associated with the lane, and may include a condition where a distance D_center between a center L_center of the lane 2 and a center V_center of the vehicle 1 is less than a predetermined threshold value, a condition where an angle diff_dir of an advancing direction Vx_dir of the vehicle 1 relative to an extension direction Lx_dir of the lane 2 that is determined based on the filtered data of the lane is less than a predetermined threshold value, a condition where the angle diff_dir of the advancing direction Vx_dir of the vehicle 1 relative to the extension direction Lx_dir of the lane 2 is less than a predetermined threshold value, a condition where the speed of the vehicle 1 on the lane 2 is within a range defined by a lower limit and an upper limit, and a condition where the vehicle 1 travels along two lines 81, 82 that define the lane 2 in the width direction Y.

The first processor 62 according to an embodiment of the disclosure may determine whether the above-described one or more second conditions are all satisfied, and may determine whether the third condition described later is satisfied when all of the second conditions are satisfied. When any one of the second conditions is not satisfied, the first processor 62 may continue to determine whether the one or more first conditions and the one or more second conditions are satisfied until all of the first conditions and all of the second conditions are satisfied.

In the disclosure, the one or more third conditions may be related to driving characteristics of the vehicle, and may include a condition where an acceleration of the vehicle 1 in the extension direction Lx_dir of the lane 2 is less than a threshold value, a condition where an acceleration of the vehicle 1 in the width direction Y of the lane 2 is less than a threshold value, a condition where an angular acceleration of the vehicle 1 rotating relative to the lane 2 (that is, an angular acceleration of rotation on the axis in the Z direction) is less than a threshold value, a condition where a torque applied to a steering axis of the vehicle 1 by at least one of a driver and an environment of the lane 2 is less than a predetermined threshold value, and a condition where a torque applied to the steering axis by the vehicle 1 according to a control signal of the vehicle 1 is less than a predetermined threshold value.

The first processor 62 according to an embodiment of the disclosure may determine whether the above-described one or more third conditions are all satisfied, and may determine a second offset according to a process described later only when all of the conditions are satisfied. On the other hand, when any one of the third conditions is not satisfied, the first processor 62 may continue to determine whether the one or more first conditions, the one or more second conditions, and the one or more third conditions are satisfied until all of the first conditions, all of the second conditions, and all of the third conditions are satisfied.

The acceleration in the extension direction Lx_dir of the lane 2 described above may be generated according to the acceleration of the vehicle 1. The acceleration of the vehicle 1 in the width direction Y of the lane 2 may be generated according to a draught on the vehicle 1 or a gradient of the lane 2. In addition, the rotation of the vehicle 1 relative to the lane 2 and the torque applied to the steering axis of the vehicle 1 by the driver may be generated according to user's manipulation of the steering wheel (not shown). The torque applied to the steering axis by the environment may be generated by flatness of the lane 2. The torque applied to the steering axis by the vehicle 1 according to the control signal of the vehicle 1 may be generated by a lane 2 keeping function, a lane departure prevention function of the vehicle 1. However, the listed situations are exemplary and the idea of the disclosure is not limited thereto.

The first processor 62 according to another embodiment of the disclosure may determine whether the one or more first conditions, the one or more second conditions and the one or more third conditions described above are satisfied regardless of the order of the conditions. For example, the first processor 62 may determine whether all of the conditions are satisfied in parallel. In addition, the first processor 62 may determine whether the one or more third conditions are satisfied, first, and then, may determine whether the one or more first conditions and then the one or more second conditions are satisfied. However, the above-described order is exemplary and the idea of the disclosure is not limited thereto.

The first processor 62 according to an embodiment of the disclosure may determine the second offset which is a candidate offset for the first drive, based on a duration for which the one or more first conditions, the one or more second conditions, and the one or more third conditions described above are satisfied, and the first offset.

For example, when a length of a time period for which the one or more first conditions, the one or more second conditions, and the one or more third conditions described above are continuously satisfied in a state in which the first offset is applied to the steering control angle exceeds a predetermined threshold length, the first processor 62 may determine the second offset to be the same value as the first offset.

The first processor 62 according to an embodiment of the disclosure may determine a third offset which is an offset to be applied to the steering angle control of the vehicle 1, based on the one or more reference offsets determined in the one or more second drives before the first drive, and the second offset which is determined according to the above-described process.

For example, the first processor 62 according to an embodiment of the disclosure may determine a representative value of the one or more reference offsets and the second offset in a predetermined method. In addition, the first processor 62 may determine the determined representative value as the third offset.

In this case, the first processor 62 may determine the representative value in various methods. For example, the first processor 62 may use one of a mode value, a median value, and an average value of the one or more reference offsets and the second offset as the representative value. However, this is merely an example and the idea of the disclosure is not limited thereto.

The first processor 62 according to an embodiment of the disclosure may apply the determined third offset to the steering angle control of the vehicle.

In the disclosure, ‘applying the offset to the steering angle control of the vehicle’ may refer to controlling the steering of the vehicle 1 with reference to the offset. For example, the first processor 62 may apply the offset to a steering angle detected by the electronic power steering 41 to use the offset for the lane keeping control of the vehicle 1. In addition, the first processor 62 may apply the offset to a steering angle generated for the lane keeping control to use the offset for the lane keeping control of the vehicle 1. However, this is merely an example and the idea of the disclosure is not limited thereto.

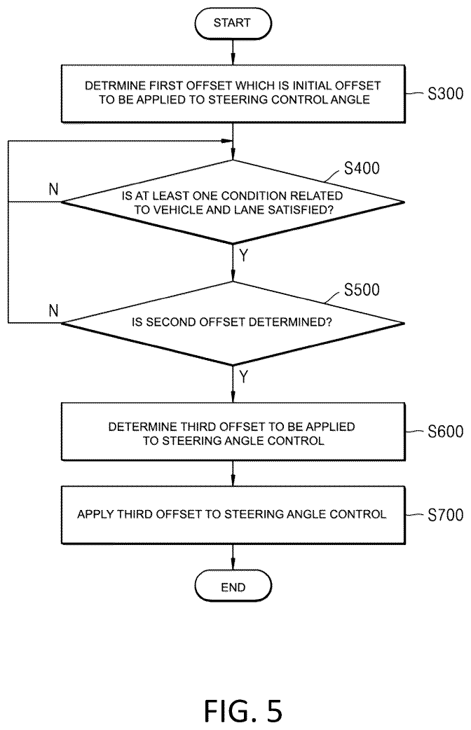

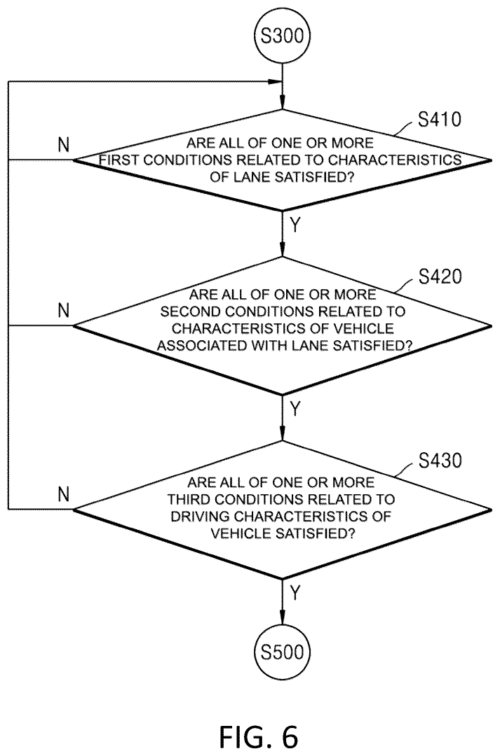

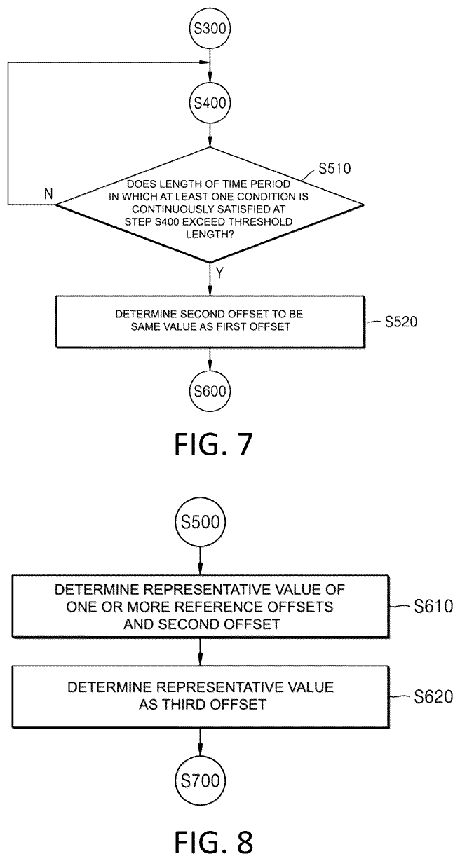

Accordingly, the disclosure may dynamically calculate the offset considering the state of the vehicle and may apply the offset to control of the vehicle, and may enhance the stability of an advanced driver assist system mounted in the vehicle due to the dynamic application of the FIGS. 5 to 8 are flowcharts to explain a steering control angle compensation method performed by the first processor 62 according to an embodiment of the disclosure. Hereinafter, the disclosure will be described by referring to FIGS. 5 to 8 together.

The first processor 62 according to an embodiment of the disclosure may determine a first offset which is an initial offset to be applied to a steering control angle in a first drive (S300).

For example, the first processor 62 according to an embodiment of the disclosure may determine the first offset based on one or more reference offsets that are stored in a memory (not shown) of the camera module 60 or a memory (not shown) of other modules. For example, the first processor 62 may determine the first offset to be +0.3 degree by referring to +0.3 degree which is an offset of the previous drive. However, this is merely an example and the idea of the disclosure is not limited thereto.

The ‘reference offset’ in the disclosure may refer to an offset that is determined in one or more second drives before the first drive.

In the disclosure, the ‘first drive’ may refer to a corresponding drive. In this case, the ‘corresponding drive’ may refer to a drive that is defined by the time from the start of the vehicle 1 to the end of the drive. Accordingly, the ‘second drive’ may refer to a previous drive that is defined by the start and end of the drive before the corresponding drive.

The first processor 62 according to an embodiment of the disclosure may determine whether at least one condition of one or more first conditions related to characteristics of the lane 2 where the vehicle travels during the first drive, one or more second conditions related to characteristics of the vehicle 1 associated with the lane 2, and one or more third conditions related to driving characteristics of the vehicle 1 is satisfied (S400).

FIG. 3 is a view illustrating a list of detailed conditions belonging to the first condition, the second condition, and the third condition described above. FIG. 4 is a view to explain parameters used for describing the detailed conditions. Hereinafter, the disclosure will be described by referring to FIGS. 3 and 4 together.

In the disclosure, the one or more first conditions may be related to characteristics of the lane, and may include a condition where the lane 2 corresponds to a straight line lane, a condition where a curvature of the lane 2 is less than a predetermined threshold value, a condition where a change rate of the curvature per unit length of the lane 2 is less than a predetermined threshold value, a condition where the length of the lane 2 exceeds a predetermined threshold value, and a condition where the curvature of the lane 2 determined from filtered data of the lane is less than a predetermined threshold value.

The first processor 62 according to an embodiment of the disclosure may determine whether the above-described one or more first conditions are all satisfied, and may determine whether the second condition described later is satisfied when all of the first conditions are satisfied (S410).

When any one of the first conditions is not satisfied, the first processor 62 may continue to determine whether the one or more first conditions are satisfied until all of the first conditions are satisfied.

In the disclosure, the ‘filtered data of the lane’ may refer to data that results from passing of image data obtained by the camera 61 through a filter having a predetermined pass band. For example, the filtered data of the lane may refer to a data that results from passing of image image through a low-frequency filter. However, this is merely an example and the idea of the disclosure is not limited thereto.

In the disclosure, conditions without restrictions on filtering, such as whether the lane 2 corresponds to a straight line lane and whether the curvature of the lane 2 is less than a predetermined threshold may be determined based on image data that is obtained by the camera 61.

The first condition may further include a condition where reliability of an image acquisition device which provides an image related to the first drive exceeds a predetermined threshold value, in addition to the above-described conditions. For example, the first condition may further include a condition where reliability of the camera 61 exceeds a predetermined threshold value.

In the disclosure, the one or more second conditions may be related to characteristics of the vehicle associated with the lane, and may include a condition where a distance D_center between a center L_center of the lane 2 and a center V_center of the vehicle 1 is less than a predetermined threshold value, a condition where an angle diff_dir of an advancing direction Vx_dir of the vehicle 1 relative to an extension direction Lx_dir of the lane 2 that is determined based on the filtered data of the lane is less than a predetermined threshold value, a condition where the angle diff_dir of the advancing direction Vx_dir of the vehicle 1 relative to the extension direction Lx_dir of the lane 2 is less than a predetermined threshold value, a condition where the speed of the vehicle 1 on the lane 2 is within a range defined by a lower limit and an upper limit, and a condition where the vehicle 1 travels along two lines 81, 82 that define the lane 2 in the width direction Y.

The first processor 62 according to an embodiment of the disclosure may determine whether the above-described one or more second conditions are all satisfied, and may determine whether the third condition described later is satisfied when all of the second conditions are satisfied (S420).

When any one of the second conditions is not satisfied, the first processor 62 may continue to determine whether the one or more first conditions and the one or more second conditions are satisfied until all of the first conditions and all of the second conditions are satisfied.

In the disclosure, the one or more third conditions may be related to driving characteristics of the vehicle, and may include a condition where an acceleration of the vehicle 1 in the extension direction Lx_dir of the lane 2 is less than a threshold value, a condition where an acceleration of the vehicle 1 in the width direction Y of the lane 2 is less than a threshold value, a condition where an angular acceleration of the vehicle 1 rotating relative to the lane 2 (that is, an angular acceleration of rotation on the axis in the Z direction) is less than a threshold value, a condition where a torque applied to a steering axis of the vehicle 1 by at least one of a driver and an environment of the lane 2 is less than a predetermined threshold value, and a condition where a torque applied to the steering axis by the vehicle 1 according to a control signal of the vehicle 1 is less than a predetermined threshold value.

The first processor 62 according to an embodiment of the disclosure may determine whether the above-described one or more third conditions are all satisfied, and may determine a second offset according to a process described later only when all of the conditions are satisfied (S430).

On the other hand, when any one of the third conditions is not satisfied, the first processor 62 may continue to determine whether the one or more first conditions, the one or more second conditions, and the one or more third conditions are satisfied until all of the first conditions, all of the second conditions, and all of the third conditions are satisfied.

The acceleration in the extension direction Lx_dir of the lane 2 described above may be generated according to an acceleration of the vehicle 1. The acceleration of the vehicle 1 in the width direction Y of the lane 2 may be generated according to a draught on the vehicle 1 or a gradient of the lane 2. In addition, the rotation of the vehicle 1 relative to the lane 2 and the torque applied to the steering axis of the vehicle 1 by the driver may be generated according to user's manipulation of the steering wheel (not shown). The torque applied to the steering axis by the environment may be generated by flatness of the lane 2. The torque applied to the steering axis by the vehicle 1 according to the control signal of the vehicle 1 may be generated by a lane 2 keeping function, a lane departure prevention function of the vehicle 1. However, the listed situations are exemplary and the idea of the disclosure is not limited thereto.

The first processor 62 according to another embodiment of the disclosure may determine whether the one or more first conditions, the one or more second conditions and the one or more third conditions described above are satisfied regardless of the order of the conditions. For example, the first processor 62 may determine whether all of the conditions are satisfied in parallel. In addition, the first processor 62 may determine whether the one or more third conditions are satisfied, first, and then, may determine whether the one or more first conditions and then the one or more second conditions are satisfied. However, the above-described order is exemplary and the idea of the disclosure is not limited thereto.

The first processor 62 according to an embodiment of the disclosure may determine the second offset which is a candidate offset for the first drive, based on a duration for which the one or more first conditions, the one or more second conditions, and the one or more third conditions described above are satisfied, and the first offset. In addition, the first processor 62 may perform step S600, which will be described later, only when the second offset is determined, and may repeat steps S400 and S500 when the second offset is not determined (S500).

The first processor 62 according to an embodiment of the disclosure may determine whether a length of a time period for which the one or more first conditions, the one or more second conditions, and the one or more third conditions are continuously satisfied in a state in which the first offset is applied to the steering control angle exceeds a predetermined threshold length (S510), and may determine the second offset to be the same value as the first offset when the length of the time period exceeds the predetermined threshold length (S520).

When the length of the time period for which the one or more first conditions, the one or more second conditions, and the one or more third conditions are continuously satisfied in the state in which the first offset is applied to the steering control angle does not exceed the predetermined threshold length, the first processor 62 may repeatedly perform steps S400 and S500 described above.

The first processor 62 according to an embodiment of the disclosure may determine a third offset which is an offset to be applied to the steering angle control of the vehicle 1, based on the one or more reference offsets determined in the one or more second drives before the first drive, and the second offset which is determined according to the above-described process (S600).

For example, the first processor 62 according to an embodiment of the disclosure may determine a representative value of the one or more reference offsets and the second offset in a predetermined method. In addition, the first processor 62 may determine the determined representative value as the third offset.

In this case, the first processor 62 may determine the representative value in various methods. For example, the first processor 62 may use one of a mode value, a median value, and an average value of the one or more reference offsets and the second offset as the representative value. However, this is merely an example and the idea of the disclosure is not limited thereto.

The first processor 62 according to an embodiment of the disclosure may apply the determined third offset to the steering angle control of the vehicle (S600).

In the disclosure, ‘applying the offset to the steering angle control of the vehicle’ may refer to controlling the steering of the vehicle 1 with reference to the offset. For example, the first processor 62 may apply the offset to a steering angle detected by the electronic power steering 41 to use the offset for the lane keeping control of the vehicle 1. In addition, the first processor 62 may apply the offset to a steering angle generated for the lane keeping control to use the offset for the lane keeping control of the vehicle 1. However, this is merely an example and the idea of the disclosure is not limited thereto.

Accordingly, the disclosure may dynamically calculate the offset considering the state of the vehicle and may apply the offset to control of the vehicle, and may enhance the stability of an advanced driver assist system mounted in the vehicle due to the dynamic application of the Embodiments according to the disclosure as described above may be implemented in the form of a computer program that is executed through various components on a computer, and such a computer program may be recoded on a computer-readable medium. In this case, the medium may store a computer-executable program. Examples of the medium include magnetic media such as hard disks, floppy disks and magnetic tapes, optical recording media such as CD-ROMs and DVDs, magneto-optical media such as floptical disks, and ROMs, RAMs and flash memories that are configured to store program instructions.

The computer program may be specially designed and configured for the disclosure, or may be well known to and usable by a person skilled in the art of computer software. Examples of the computer program may include machine language codes created by a compiler, and high-level language codes that can be executed by a computer by using an interpreter.

Specific executions explained in the disclosure are exemplary and are not intended to limit the scope of the disclosure in any way. For the sake of brevity, descriptions of related-art electronic components, control systems, software, other functional aspects of the systems may be omitted. In addition, connecting lines or connecting members among components shown in the drawings are only examples of functional connection and/or physical or circuitry connections. In an actual device, connections among components may be represented by a variety of alternative or additional functional connection, physical connection, or circuit connections. Furthermore, if there is no specific mention such as “essential,” “importantly,” or the like, it may not be a necessary component for the application of the disclosure.

Therefore, the idea of the disclosure should not be defined only by the embodiments described above, and not only the claims which will be described below but also all ranges equivalent to the claims or changed equivalently therefrom will be said to belong to the scope of the idea of the disclosure.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### EXPLANATION OF SIGNS

1: Vehicle
10: Engine
11: Engine management system
20: Transmission
21: Transmission control unit
30: Brake device
31: Electronic brake control module
40: Steering device
41: Electronic power steering
42: Torque sensor
50: Body control module
60: Camera module
61: Camera
62: First processor
70: Radar module
71: Radar
72: Second processor

What is claimed is:

1. A steering control angle compensation method for lane keeping performed by a processor, the steering control angle compensation method comprising:
determining a first offset which is an initial offset to be applied to a steering control angle in a first drive;
determining whether at least one condition of one or more first conditions related to characteristics of a lane on which driving is performed in the first drive, one or more second conditions related to characteristics of a vehicle associated with the lane in the first drive, and one or more third conditions related to driving characteristics of the vehicle in the first drive is satisfied;
determining a second offset which is a candidate offset for the first drive, based on a duration for which the at least one condition is satisfied and the first offset; and
determining a third offset which is an offset to be applied to a steering angle control of the vehicle, based on one or more reference offsets that are determined in one or more second drives before the first drive, and the second offset.

2. The steering control angle compensation method for lane keeping of claim 1, wherein determining the first offset further includes determining the first offset based on the one or more reference offsets stored in a memory.

3. The steering control angle compensation method for lane keeping of claim 1, wherein determining whether the at least one condition is satisfied further includes:
determining whether the one or more first conditions related to the characteristics of the lane on which driving is performed in the first drive are satisfied;
determining whether the one or more second conditions related to the characteristics of the vehicle associated with the lane in the first drive are satisfied; and
determining whether the one or more third conditions related to the driving characteristics of the vehicle in the first drive are satisfied.

4. The steering control angle compensation method for lane keeping of claim 3, wherein the one or more first conditions include:
a condition where the lane corresponds to a straight line lane, a condition where a curvature of the lane is less than a predetermined threshold value, a condition where a change rate in the curvature per unit length of the lane is less than a predetermined threshold value, a condition where a length of the lane exceeds a predetermined threshold value, and a condition where the curvature of the lane determined from filtered data of the lane is less than a predetermined threshold value.

5. The steering control angle compensation method for lane keeping of claim 4, wherein the first condition is determined based on an image related to the first drive of the vehicle, and
wherein the one or more first conditions further include a condition where a reliability of an image acquisition device which provides an image related to the first drive exceeds a predetermined threshold value.

6. The steering control angle compensation method for lane keeping of claim 3, wherein the one or more second conditions include:
a condition where a distance between a center of the lane and a center of the vehicle is less than a predetermined threshold value, a condition where an angle of an advancing direction of the vehicle relative to an extension direction of the lane that is determined based on filtered data of the lane is less than a predetermined threshold value, a condition where the angle of the advancing direction of the vehicle relative to the extension direction of the lane is less than a predetermined threshold value, a condition where a speed of the vehicle on the lane is within a range that is defined by a lower limit and an upper limit, and a condition where the vehicle travels along two lines which define the lane in a width direction.

7. The steering control angle compensation method for lane keeping of claim 3, wherein the one or more third conditions include:
a condition where an acceleration of the vehicle in an extension direction of the lane is less than a threshold value, a condition where an acceleration of the vehicle in a width direction of the lane is less than a threshold value, a condition where an angular acceleration of the vehicle rotating relative to the lane is less than a threshold value, a condition where a torque applied to a steering axis of the vehicle by at least one of a driver and an environment of the lane is less than a predetermined threshold value, and a condition where a torque applied to the steering axis by the vehicle according to a control signal of the vehicle is less than a predetermined threshold value.

8. The steering control angle compensation method for lane keeping of claim 1, wherein determining the second offset further includes:
when a length of a time period for which the at least one condition is continuously satisfied in a state in which the first offset is applied to the steering control angle exceeds a predetermined threshold length, determining the second offset to be the same value as the first offset.

9. The steering control angle compensation method for lane keeping of claim 1, wherein determining the third offset further includes:
determining a representative value of the one or more reference offsets and the second offset in a predetermined method; and
determining the representative value as the third offset.

10. The steering control angle compensation method for lane keeping of claim 1, further comprising:
after the step of determining the third offset, applying the third offset to the steering angle control of the vehicle.

11. A lane keeping control device comprising a processor,
wherein the processor is configured to:
determine a first offset which is an initial offset to be applied to a steering control angle in a first drive;
determine whether at least one condition of one or more first conditions related to characteristics of a lane on which driving is performed in the first drive, one or more second conditions related to characteristics of a vehicle associated with the lane in the first drive, and one or more third conditions related to driving characteristics of the vehicle in the first drive is satisfied;
determine a second offset which is a candidate offset for the first drive, based on a duration for which the at least one condition is satisfied, and the first offset; and
determine a third offset which is an offset to be applied to steering angle control of the vehicle, based on one or more reference offsets that are determined in one or more second drives before the first drive, and the second offset.

12. A vehicle comprising a lane keeping control device, wherein the lane keeping control device is configured to:
determine a first offset which is an initial offset to be applied to a steering control angle in a first drive;
determine whether at least one condition of one or more first conditions related to characteristics of a lane on which driving is performed in the first drive, one or more second conditions related to characteristics of a vehicle associated with the lane in the first drive, and one or more third conditions related to driving characteristics of the vehicle in the first drive is satisfied;
determine a second offset which is a candidate offset for the first drive, based on a duration for which the at least one condition is satisfied, and the first offset; and
determine a third offset which is an offset to be applied to steering angle control of the vehicle, based on one or more reference offsets that are determined in one or more second drives before the first drive, and the second offset.
